(19) United States
(12) Patent Application Publication
(10) Pub. No.: US 2026/0081366 A1
(43) Pub. Date: Mar. 19, 2026

(54) POWER LINE CLAMP WITH TELESCOPING SCREW

(71) Applicant: Hubbell Incorporated, Shelton, CT (US)

(72) Inventor: Pieter Jere Beckman, Nottingham, NH (US)

(21) Appl. No.: 19/328,830

(22) Filed: Sep. 15, 2025

Related U.S. Application Data
(60) Provisional application No. 63/695,062, filed on Sep. 16, 2024.

(51) Int. Cl. H01R 4/30; H01R 4/36; H01R 11/05; H02G 1/04

(52) U.S. Cl. CPC H01R 4/307; H01R 4/305; H01R 4/366; H01R 11/05; H02G 1/04

(57) ABSTRACT

An electrical connector includes a clamp body having a base, a side portion, and an upper portion. The clamp body defines a cable groove configured to receive a primary conductor and an aperture for receiving a secondary conductor. A primary fastener is movably connected to the clamp body. The primary fastener has a first section and second section telescopically connected to the first section. A keeper is connected to the clamp body and moveable with the primary fastener to secure the primary conductor in the cable groove. A secondary fastener is configured to receive the secondary conductor in the aperture.

### RELATED APPLICATION(S)

This application is based on U.S. Provisional Application Ser. No. 63/695,062, filed Sep. 16, 2024, the disclosure of which is incorporated herein by reference in its entirety and to which priority is claimed.

### FIELD

Various exemplary embodiments relate to an electrical connector for a utility power line.

### BACKGROUND

A power line clamp connector is used to make a permanent or temporary connection to an overhead power distribution line. Some examples of power line clamp connectors include hotline clamps and piggyback clamps which are used to connect a tap line to a primary conductor. These types of clamps can be used to hold a tap line in position with a main conductor while a more permanent connection is made. Typically, these connectors are installed by a lineman using a hot stick.

### SUMMARY

Certain configurations include an electrical connector including a clamp body having a base, a side portion, and an upper portion. The clamp body defines a cable groove configured to receive a primary conductor and an aperture for receiving a secondary conductor. A primary fastener is movably connected to the clamp body. The primary fastener has a first section and second section telescopically connected to the first section. A keeper is connected to the clamp body and moveable with the primary fastener to secure the primary conductor in the cable groove. A secondary fastener is configured to receive the secondary conductor in the aperture.

In certain configurations, an electrical connector includes a clamp body having a base, a side portion, and an upper portion. The clamp body defines a cable groove configured to receive a primary conductor and an aperture for receiving a secondary conductor. A primary fastener is movably connected to the clamp body. The primary fastener has a first section and second section telescopically connected to the first section. A keeper is connected to the clamp body and moveable with the primary fastener to secure the primary conductor in the cable groove. A secondary fastener is configured to receive the secondary conductor in the aperture.

In certain configurations, an electrical connector includes a clamp body having a base, a side portion, and an upper portion. The clamp body defines a first cable groove configured to receive a conductor. A primary fastener is movably connected to the clamp body. The primary fastener includes a first section and a second section rotatably connected to the first section. A keeper is connected to the clamp body and moveable with the primary fastener to secure the primary conductor in the first cable groove. Rotation of the first section causes linear movement of the second section relative to the first section.

### BRIEF DESCRIPTION OF THE DRAWINGS

The aspects and features of various exemplary configurations will be more apparent from the description taken with reference to the accompanying drawings.

FIG. 1 is a perspective view of an electrical connector.

FIG. 2 is a side view of FIG. 1.

FIG. 3 is a side, magnified view of the cable groove of the connector.

FIG. 4 is a perspective, magnified view of the cable groove of FIG. 3.

FIG. 5 is a side view of a fastener in a retracted position.

FIG. 6 is a side view of the fastener of FIG. 5 in an extended position.

FIG. 7 is a sectional view of FIG. 6.

FIG. 8 is a side view of the fastener connected to a clamp in a retracted position.

FIG. 9 is a side view of FIG. 8 with the fastener in an extended position.

FIG. 10 is a side view of the fastener connected to a clamp and a keeper in an extended position.

FIG. 11 is a sectional view of FIG. 10.

FIG. 12 is a perspective view of the keeper of FIG. 10.

FIG. 13 is a side view of FIG. 12.

FIG. 14 is a side view of another configuration of a fastener in a retracted position.

FIG. 15 is a side view of the fastener of FIG. 12 in the extended position.

### DETAILED DESCRIPTION OF EXEMPLARY EMBODIMENTS

Various implementations are directed to an electrical connector configured to electrically connect a first electrical conductor to a second electrical conductor. In certain configurations the electrical conductors can be utility line power conductors. The first conductor can be a main conductor such as a run cable, or feeder cable conductor for example. The second conductor can be a tap wire, or tap line conductor for example. However, it should be understood that alternative embodiments may accommodate any combination of conductor types and/or sizes.

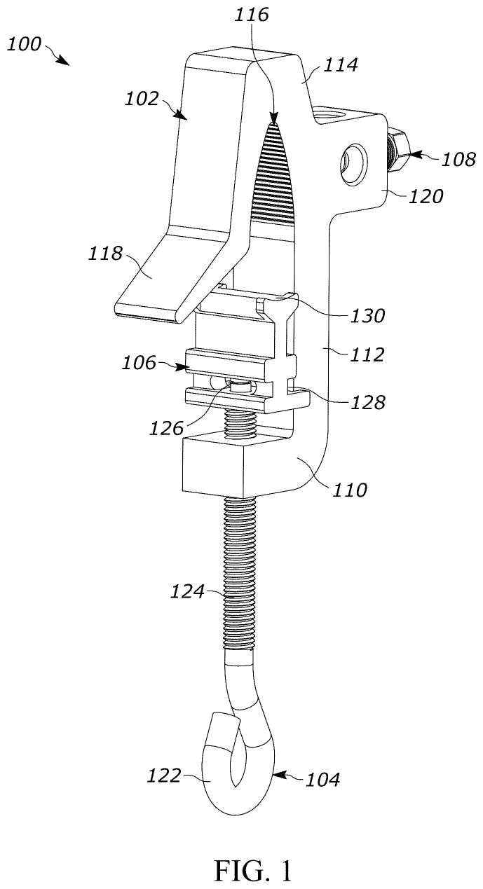

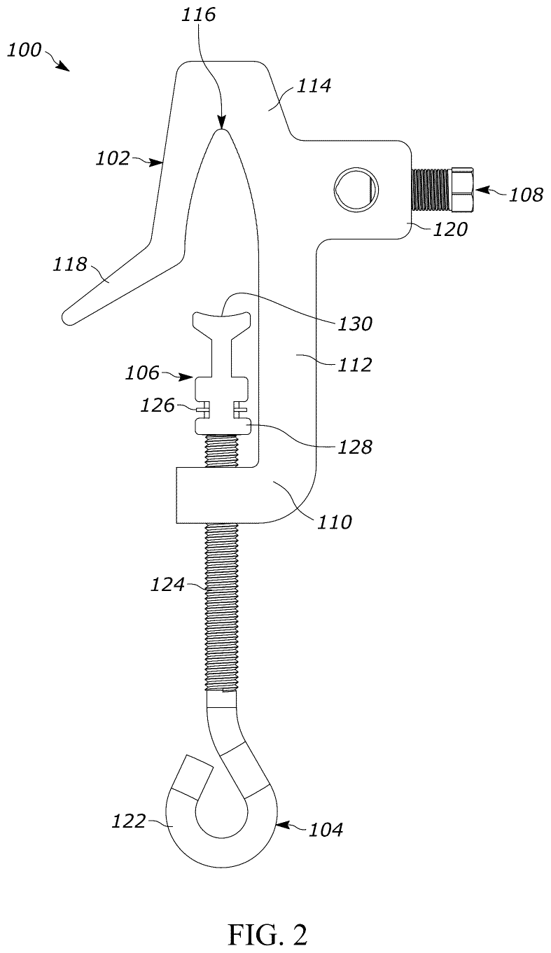

FIG. 1 shows an exemplary embodiment of a connector 100 having a hot line clamp configuration. The connector 100 has a clamp body 102, a primary fastener 104, a keeper 106, and a secondary fastener 108. The hot line connector 100 is configured to receive a primary conductor and a secondary conductor in the clamp body 102 to make an electrical connection between the two conductors.

In various embodiments, the clamp body includes a base 110 with an aperture for receiving the primary fastener 104. A side portion 112 extends upwardly from the base 110. An upper portion 114 extends outwardly from the side portion 112 and defines a cable groove 116. The upper portion 114 can include a forward extension 118 which extends outwardly from the cable groove 116. The forward extension 118 can extend at an oblique angle away from the cable groove 116 and down toward the base 110.

A boss 120 extends from the rear of the upper portion 114. The boss 120 includes an aperture for receiving the secondary fastener and one or more apertures from receiving a secondary conductor. The secondary or tap conductor can be inserted into one of the openings in the boss 120 and the secondary fastener 108 can be tightened to secure the secondary conductor.

In certain configurations the primary fastener 104 includes an eye 122 and a threaded portion 124. The keeper 106 is connected to the end of the primary fastener 104 by a retaining ring 126. In an exemplary operation, the eye 122 can be engaged by a hot stick and the primary fastener 104 rotated to move the keeper 106 relative to the cable groove 116 to retain a conductor. The keeper 106 can be rotatably connected to the primary fastener 104 so that rotational position of the keeper 106 remains relatively steady with respect to the primary fastener 104 during rotation. The keeper 106 can include a keeper body 128 having one or more projections. The upper projection can include a curved outer surface 130 for receiving a conductor.

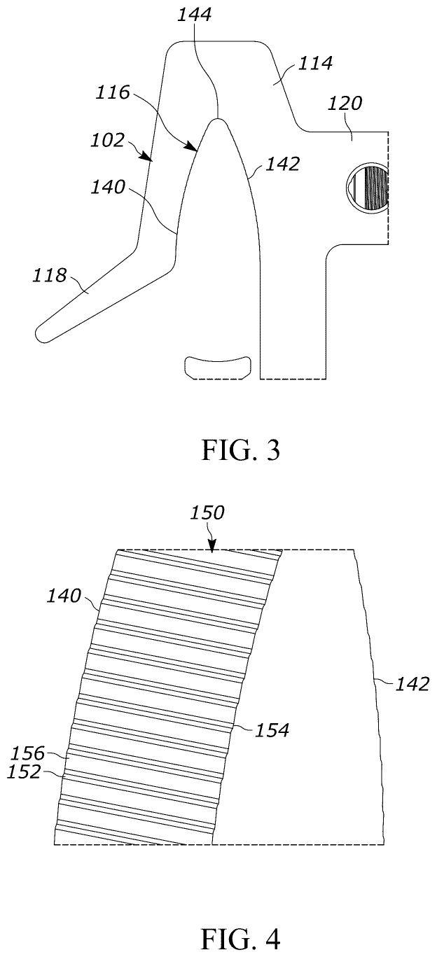

The cable groove 116 is configured to receive various sized primary conductors. As best shown in FIG. 3, the cable groove 116 can include an outer wall 140, an inner wall 142, and an upper wall 144. In certain configurations, the outer wall 140, inner wall 142, and upper wall 144 can have an arched configuration. In the illustrated embodiment the cable groove has a substantially ogival (aka gothic) arch configuration with a curving outer wall 140, inner wall 142, and a pointed upper wall 144. Although an ogival arch is shown, various other arched configurations can be used with different curved sides and other crown or point configurations. For example, other embodiments can utilize a segmented, semicircular, trefoil, basket, parabolic, tudor, rampant, acute, or ogee arch configuration can be used.

Typical clamps utilize a V-shaped cable groove with substantially rectilinear sides meeting in a point. The arched configuration provides improvements of the V-shaped design in that the curvature of the arch can help form enhanced contact with the conductor when pressed into the cable groove 116. The arched configuration can also be easier to release the conductor, as a V-shaped groove can require more force to deform and seat the conductor during installation. The arched configuration can also allow for a greater range of conductors to be used. For example, various embodiments of hot line connectors can be configured to operate in a small range, with a main conductor range of #4 to 4/0 ACSR or a diameter of 0.232 to 0.563 inches and a tap conductor range of #8 to 2/0 AAC or a diameter of 0.128 to 0.414 inches, a medium range, with a main conductor range of 1/0 to 795 AAC or a diameter of 0.368 to 1.027 inches or a tap conductor range of #8 to 4/0 AAC or a diameter of 0.128 to 0.522 inches, and a large range, with a main conductor range of 636 to 1033.5 ACSR or a diameter of 0.918 to 1.245 inches and a tap conductor range of #8 to 4/0 AAC or a diameter of 0.128 to 0.522 inches.

In some configurations, the cable groove 116 can include a plurality of teeth 150 as best shown in FIG. 4. Each of the teeth 150 can have a first side 152, a peak 154, and a second side 156. The teeth can have an angled, stepped configuration so that the first side 152 is shorter than the second side 156 and the peak 154 is at a downward, oblique angle relative to the outer wall 140 and inner wall 142. This configuration can allow the teeth 150 to better grip the primary conductor and provide abrasion during insertion that facilitates a better connection, while also allowing for easier removal of the primary conductor if needed.

In certain configurations, a fastener can be utilized with a clamp that provides for greater efficiency during installation. In some installations, connectors requiring longer threaded hardware can lead to installer frustration due to excessive numbers of rotations to fully tighten the fastener to engage the keeper with the conductor. Connectors often need to be installed manually without power tools and in high volumes. Fasteners with lower rotation to linear travel ratios can therefore provide a benefit.

In certain configurations, a fastener can be provided which has multiple threaded components, which can lead to easier installation. In some configurations, the fastener can include two threaded components. In other configurations, more than two threaded components can be used.

In certain configurations the fastener can include a primary threaded component and a secondary threaded component. The primary threaded component can include an external threaded component and an internal threaded component. The secondary threaded component can include a shaft with external threads to mate with the internal threads of the primary component.

In certain configurations, the internal and external threaded components can have opposite orientations. For example, the external threaded component can have a right-hand orientation and the internal threaded component can have a left-hand orientation.

In certain configurations the external thread of the primary component has an equal pitch to the secondary component. In other configurations, the primary component has a coarser pitch than the secondary component. This can allow for faster coarse adjustment by rotating the primary component and finer adjustments by rotating the secondary component.

The fastener can take a number of different forms, with different hand and tool interfaces as required for a specific application. The size and shape of the overall fastener can be varied as needed. The size and pitch of the threads can also be varied.

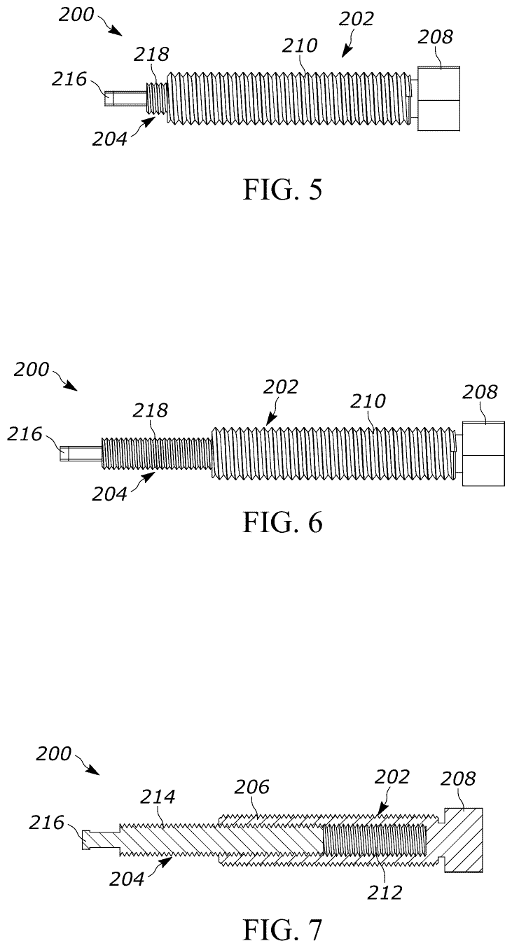

FIGS. 5-7 shows an example of a fastener 200 having primary section 202 and a secondary section 204. The secondary section 204 is moveable relative to the primary section 202 between one or more retracted positions to one or more extended positions.

The primary section can include a cylindrical body 206 and a head 208 for driving the primary section 202. The illustrated configuration shows a hex head 208, though any type of tool interface or manual or hand interface can be used.

The primary section 202 can include a primary exterior threaded component 210. The primary exterior threaded component 210 can wrap around at least substantial portion of the primary section 202. In certain configurations, the primary exterior threaded component 210 can have a continuous thread. The thread can be configured to mate with an electrical connector, for example a utility line clamp. The primary exterior threaded component 210 can be a male thread, projecting from the cylindrical body 206 of the primary section 202.

The body 206 of the primary section 202 can have a substantially hollow cylindrical configuration, with an open end permitting access to an interior as best shown in FIG. 7. The interior can include a primary interior threaded component 212. The interior threaded component 212 can include a female thread extending into the interior of the primary component body 206.

The secondary section 204 can include a secondary cylindrical body 214 and an engagement end 216. The engagement end can 216 have a substantially I-shaped configuration with a pair of opposing flat inner sections. The engagement end 216 can be configured to engage a keeper for securing an electrical conductor. In certain configurations the keeper can be rotatably fixed to the engagement end 216.

The secondary section 204 can include a secondary exterior threaded component 218. The secondary exterior threaded component 218 can wrap around at least a substantial portion of the secondary section 204. In certain configurations, the secondary exterior threaded component 218 can have a continuous thread. The thread can be configured to mate with the interior thread 212 of the primary section 202. The secondary exterior thread 218 can be a male thread, projecting from a cylindrical body 214 of the secondary section 204 and configured to mate with a female thread of the primary section 202.

The secondary section 204 can be threadably engaged with the primary section 202 so that a portion of the secondary section 204 extends into the primary section 202 and at least a portion of the secondary section 204 extends outwardly from the open end of the primary section 202. Rotation of the secondary section 204 can adjust the position relative to the primary section 202 so that the overall length of the fastener 200 can be telescopically adjusted.

In certain configurations, the primary external thread 210 and the secondary external thread 218 can have opposite orientations. For example the primary external thread 210 can have a right-hand orientation and the secondary external thread 218 can have a left-hand orientation. In this way, rotation of the primary section 202 can also cause linear movement of the secondary section 204 when the secondary section 204 is locked for rotation, for example through engagement with a keeper and a conductor in a clamp.

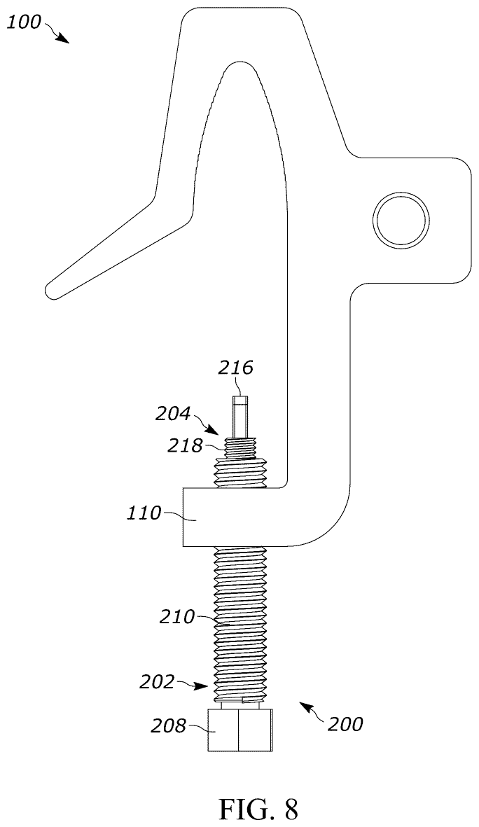

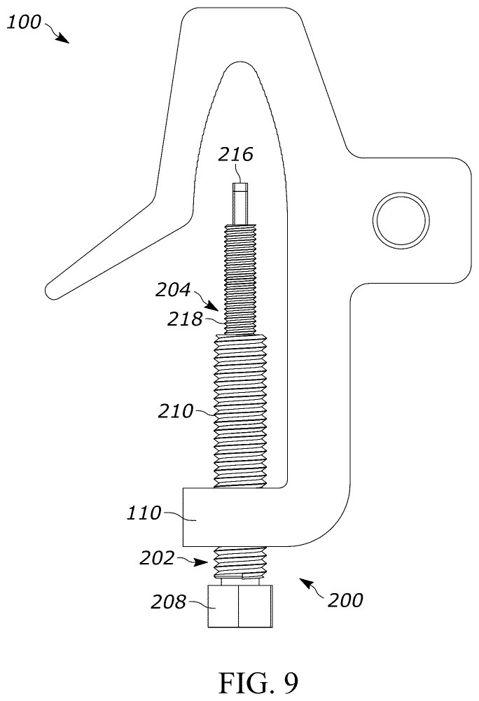

FIGS. 8 and 9 show the fastener 200 connected to an arched hotline clamp 100. The primary component is threadably connected to the base 110 of the clamp 100. When the primary component is rotated the secondary component will extend or retract in proportion to the combined primary and secondary thread pitches. For example, the primary external thread and the secondary external thread can have a pitch of 10 threads per inch. Ten rotations of the primary section will therefore result in a one inch of linear displacement of the primary section and one inch linear displacement of the secondary section for a total of two inches total linear travel.

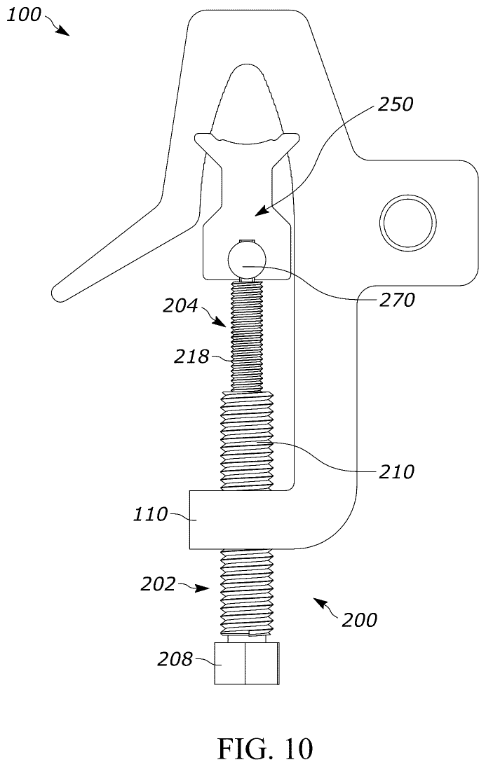

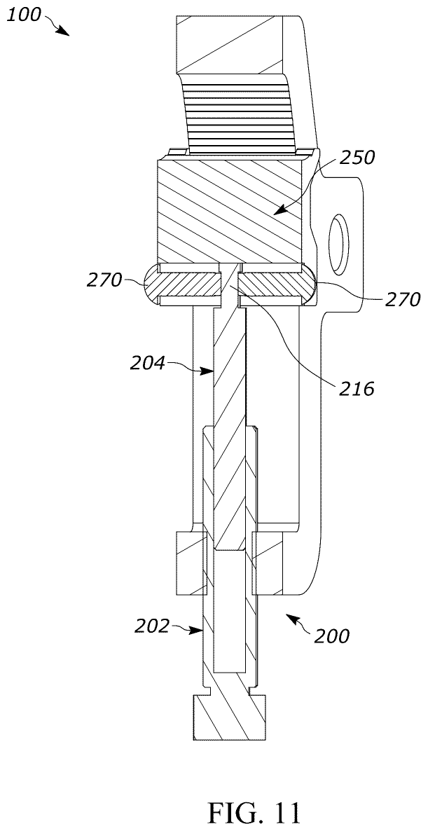

FIGS. 10 and 11 show the fastener 200 connected to a keeper 250 for engaging a conductor. The engagement end 216 of the fastener 200 can extend into the keeper 250. One or more pin, rivet, or other fastener 270 can extend through the keeper 250 to connect the engagement end 216 to the keeper 250. The secondary section 204 can be rotatably fixed to the keeper 250. Rotation of the primary section 202 therefore causes linear movement of the secondary section 204 relative to the primary section 202 to increase the speed at which the keeper 250 can be engaged and disengaged with a conductor.

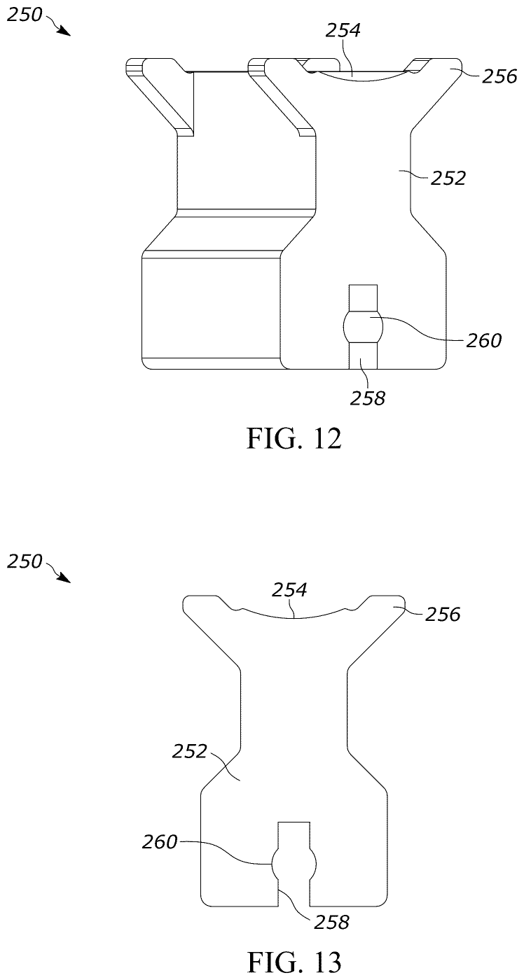

As best shown in FIGS. 12 and 13, the keeper 250 can include a body 252 having a cable groove 254 for receiving a conductor. Sets of arms 256 can extend from the body 252. The arms 256 are configured to extend outside the body of the clamp 100. A slot 258 can extend into a lower portion of the body 252. The slot 258 can include a curved recess 260 extending laterally across the body 252 and positioned above a lower edge of the slot 258. The engagement end 216 of the fastener 200 can extend into the slot 258 and the curved recess 260 can be used to retain the fasteners 270 to pin the fastener 200 in place.

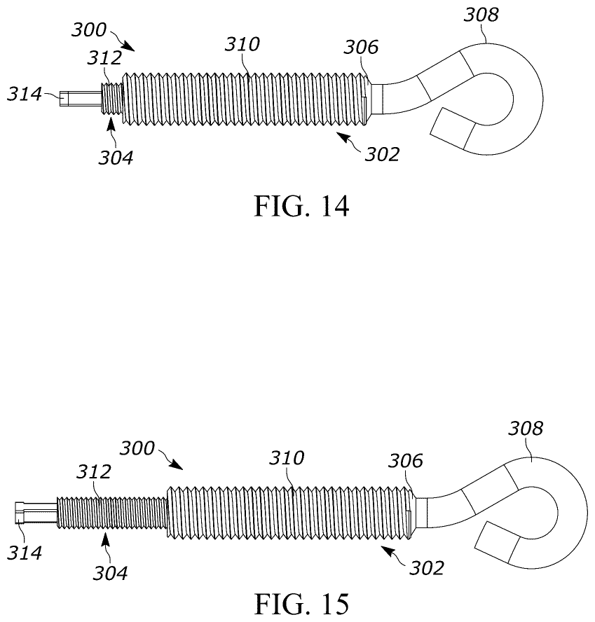

FIGS. 14 and 15 show another configuration of a fastener 300 having primary section 302 and a secondary section 304. The primary section can include a cylindrical body 306 and a head 308 for driving the primary section 302. The illustrated configuration shows an eye hook head 308, though any type of tool interface or manual or hand interface can be used. The primary section 302 can include a primary exterior threaded component 310. The secondary section 304 can include a secondary exterior threaded component 312 and an engagement head 314. The secondary exterior threaded component 312 can be threadably connected to the primary section 302 as discussed above with the fastener 200 shown in FIGS. 5-11.

The foregoing detailed description has been provided for the purpose of explaining the general principles and practical application, thereby enabling others skilled in the art to understand the disclosure for various configurations and implementations, and with various modifications as are suited to the particular uses contemplated. This description is not necessarily intended to be exhaustive or to limit the disclosure to what is disclosed. Any of the configurations and/or elements disclosed herein may be combined with one another to form various additional embodiments not specifically disclosed. Accordingly, additional configurations and implementations are possible and are intended to be encompassed within this specification and the scope of the appended claims. The specification describes specific examples to accomplish a more general goal that may be accomplished in another way.

As used in this application, the terms “front,” “rear,” “upper,” “lower,” “upwardly,” “downwardly,” and other orientational descriptors are intended to facilitate the description of the exemplary embodiments of the present disclosure, and are not intended to limit the structure of the exemplary embodiments of the present disclosure to any particular position or orientation. Terms of degree, such as “substantially” or “approximately” are understood by those of ordinary skill to refer to reasonable ranges outside of the given value, for example, general tolerances associated with manufacturing, assembly, and use of the described embodiments. Unless specified or limited otherwise, the terms “mounted,” “connected,” “supported,” and “coupled” and variations thereof are used broadly and encompass both direct and indirect mountings, connections, supports, and couplings. The words “member,” “component,” “module,” “mechanism,” “element,” “device,” and the like are not a substitute for the word “means.” As such, no claim element should be construed as a means plus function unless the element is expressly recited using the phrase “means for.”

What is claimed:

1. An electrical connector comprising:
a clamp body having a base, a side portion, and an upper portion, the clamp body defining a cable groove configured to receive a primary conductor and an aperture for receiving a secondary conductor;
a primary fastener movably connected to the clamp body, the primary fastener having a first section and second section telescopically connected to the first section;
a keeper connected to the clamp body and moveable with the primary fastener to secure the primary conductor in the cable groove; and
a secondary fastener configured to receive the secondary conductor in the aperture.

2. The electrical connector of claim 1, wherein the first section includes a first outer threaded portion and a first inner threaded portion and wherein the second section includes a second outer threaded portion configured to mate with the first inner threaded portion.

3. The electrical connector of claim 2, wherein the first outer threaded portion is threadably connected to the base.

4. The electrical connector of claim 2, wherein the first outer threaded portion has a first orientation and the second outer threaded portion has an opposite orientation.

5. The electrical connector of claim 4, wherein the first outer threaded portion has a right-hand configuration and the second outer threaded portion has a left-hand threaded configuration.

6. The electrical connector of claim 1, wherein the secondary portion is rotatably fixed to the keeper.

7. The electrical connector of claim 1, wherein the first section has a substantially cylindrical configuration with an open interior and the second section extends into the interior.

8. The electrical connector of claim 1, wherein the second section includes an engagement end having a pair of opposing flat surfaces.

9. The electrical connector of claim 1, wherein the second section is pinned to the keeper.

10. The electrical connector of claim 1, wherein the first section includes a hex head.

11. The electrical connector of claim 1, wherein the keeper includes a body, a slot extending into the body, and a curved recess extending from the slot.

12. The electrical connector of claim 11, wherein an engagement end of the second section extends into the slot of the keeper.

13. An electrical connector comprising:
a clamp body having a base, a side portion, and an upper portion, the clamp body defining a first cable groove configured to receive a conductor;
a primary fastener movably connected to the clamp body, wherein the primary fastener includes a first section and a second section rotatably connected to the first section; and
a keeper connected to the clamp body and moveable with the primary fastener to secure the primary conductor in the first cable groove,
wherein rotation of the first section causes linear movement of the second section relative to the first section.

14. The electrical connector of claim 13, wherein the first section includes a first outer threaded portion and a first inner threaded portion and wherein the second section includes a second outer threaded portion configured to mate with the first inner threaded portion.

15. The electrical connector of claim 14, wherein the first outer threaded portion is threadably connected to the base.

16. The electrical connector of claim 14, wherein the first outer threaded portion has a first orientation and the second outer threaded portion has an opposite orientation.

17. The electrical connector of claim 16, wherein the first outer threaded portion has a right-hand configuration and the second outer threaded portion has a left-hand threaded configuration.

18. The electrical connector of claim 13, wherein the secondary portion is rotatably fixed to the keeper.

19. The electrical connector of claim 13, wherein the first section has a substantially cylindrical configuration with an open interior and the second section extends into the interior.

20. The electrical connector of claim 13, wherein the second section includes an engagement end having a pair of opposing flat surfaces.
